(19) United States
(12) Patent Application Publication
(10) Pub. No.: US 2005/0154657 A1
(43) Pub. Date: Jul. 14, 2005

(54) Condition scoring for a property appraisal system

(76) Inventors: Christopher D. Y. Kim, Littleton, CO (US); Charles J. Gadd, Littleton, CO (US); Andrea Cope, Littleton, CO (US); Santiago Silva, Littleton, CO (US)

Correspondence Address: HENSLEY KIM & EDGINGTON, LLC, 1660 LINCOLN STREET, SUITE 3050, DENVER, CO, 80264, US

(21) Appl. No.: 11/034,456

(22) Filed: Jan. 12, 2005

Related U.S. Application Data
(60) Provisional application No. 60/536,107, filed on Jan. 12, 2004.
(60) Provisional application No. 60/536,111, filed on Jan. 12, 2004.
(60) Provisional application No. 60/536,215, filed on Jan. 12, 2004.

(51) Int. Cl. G06F 17/60

(52) U.S. Cl. 705/30; 705/19

(57) ABSTRACT

An appraisal system obtains reliable information relating to subjective property characteristics of a property and quantifies the contributions of such subjective characteristics on the value of the property. An appraiser enters subjective property information regarding a subject property into the appraisal system, which evaluates other properties using property data obtained from property databases to identify comparable properties. Key condition data for the comparable properties is extracted from subjective property characteristics available from the real estate property data. The key condition data for both the subject property and the comparable properties is catagorized and assigned condition scores based on the characteristic's impact on the property valuation. The condition scores for each property are combined into composite condition scores, which can be quantifiably compared with property characteristics to assist in selecting comparable properties. The condition scores of the subject property may also be employed to adjust the resulting appraisal value.

### RELATED APPLICATIONS

The present application claims benefit of U.S. Provisional Patent Application No. 60/536,107, entitled “Condition Score Appraisal”; U.S. Provisional Patent Application No. 60/536,111, entitled “Methods and Systems for Ranking Comparable Properties for Property Appraisals”; and U.S. Provisional Patent Application No. 60/536,215, entitled “Data Source Determination for Property Appraisal”, all filed on Jan. 12, 2004 and specifically incorporated by reference herein for all that they disclose and teach.

The present application is also related to U.S. patent application Ser. No. ______ [Attorney Docket No. 236-004-USP], filed Jan. 12, 2005 and entitled “Ranking Comparable Properties for Appraisal”, specifically incorporated by reference herein for all that it discloses and teaches.

### TECHNICAL FIELD

The invention relates generally to property appraisal systems, and more particularly to condition scoring in a real estate property appraisal system.

### BACKGROUND

Generally, an appraiser attempts to judge the value of a given real estate property using a variety of objective and subjective characteristics of the property. Some exemplary objective characteristics may include without limitation the location of the property, the size of the property, and the square footage of any structures on the property. A typical appraisal involves selecting recently-sold properties having characteristics similar to those of the subject property and using the recent sales prices of these “comparable” properties to set a value for the subject property.

While not trivial, objective property characteristics are relatively easy to obtain, quantify, and compare in an appraiser valuation engine. As such, existing computerized appraisal systems can employ objective property characteristics to develop comparable properties. However, subjective property characteristics are typically more difficult to obtain, less reliable in their accuracy, and more difficult to use in a quantitative comparison process of an appraisal. As such, it is generally left to the appraiser to make a subjective evaluation of subjective property characteristics and apply his or her impressions resulting from that evaluation during the selection of comparable properties and the setting of property values.

Naturally, the impact of such subjective impressions on a property valuation can vary dramatically among different appraisers and even with the same appraiser on different days. Furthermore, existing approaches have been ineffective in automating the incorporation of such subjective property characteristics into the appraisal process. As such, it is difficult to obtain consistent valuations across many property samples in a relatively fast manner.

### SUMMARY

Implementations described and claimed herein address the foregoing problems by obtaining reliable information relating to subjective property characteristics and quantifying the contributions of such subjective characteristics on the value of a property. By incorporating the subjective characteristics of a given property and the subjective characteristics of “comparable” properties, a more accurate valuation for the subject property may be obtained.

Accordingly, an appraiser can enter subjective property information regarding a subject property into an appraisal system. The appraisal system evaluates other properties using real estate property data obtained from one or more property databases to identify comparable properties. Key condition data for the comparable properties is extracted from subjective property characteristics available in or discemable from the real estate property data. The key condition data for both the subject property and the comparable properties is categorized and assigned condition scores based on the characteristic's perceived impact on the value of the property. The condition scores for each property are combined into composite condition scores, which can be quantifiably compared in combination with other objective property characteristics to assist in selecting comparable properties for the appraisal. The condition scores of the subject property may also be employed to adjust the resulting appraisal value.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program.

The computer program product encodes a computer program for a computer process executing on a computer system. The computer process quantifies condition of a real estate property. Real estate property data that includes a plurality of subjective condition characteristics relating to the real estate property is received. Key condition data is extracted from the subjective condition characteristics in the real estate property data. Elements of the key condition data are categorized into one or more predefined condition categories, wherein each predefined condition category is associated with a condition contribution score. A condition contribution score is associated with the real estate property, if an element of the key condition data is categorized in the predefined condition category associated with the condition contribution score.

In another implementation, a method is provided that quantifies condition of a real estate property. Real estate property data that includes a plurality of subjective condition characteristics relating to the real estate property is received. Key condition data is extracted from the subjective condition characteristics in the real estate property data. Elements of the key condition data are categorized into one or more predefined condition categories, wherein each predefined condition category is associated with a condition contribution score. A condition contribution score is associated with the real estate property, if an element of the key condition data is categorized in the predefined condition category associated with the condition contribution score.

In another implementation, an appraisal system that quantifies condition of a real estate property is provided. A database receives real estate property data including a plurality of subjective condition characteristics relating to the real estate property. An appraisal valuation engine extracts key condition data from the subjective condition characteristics in the real estate property data. The appraisal valuation engine also categorizes elements of the key condition data from the real estate property data into one or more predefined condition categories, wherein each predefined condition category being associated with a condition contribution score. A condition contribution score is associated with the real estate property, if an element of the key condition data is categorized in the predefined condition category associated with the condition contribution score.

In yet another implementation, a system quantifies condition of a real estate property. The system provides means for receiving real estate property data that includes a plurality of subjective condition characteristics relating to the real estate property, means for extracting key condition data from the subjective condition characteristics in the real estate property data, means for categorizing elements of the key condition data from the real estate property data into one or more predefined condition categories, each predefined condition category being associated with a condition contribution score, and means for associating a condition contribution score with the real estate property, if an element of the key condition data is categorized in the predefined condition category associated with the condition contribution score.

Other implementations are also described and recited herein.

### BRIEF DESCRIPTION OF THE DRAWINGS

FIG. 1 illustrates an exemplary system for providing property appraisals using subjective property characteristics.

FIG. 2 illustrates a login page of an exemplary appraiser valuation engine.

FIG. 3 illustrates a property identification page of an exemplary appraiser valuation engine.

FIG. 4 illustrates a portion of a condition and weighting page of an exemplary appraiser valuation engine.

FIG. 5 illustrates another portion of a condition and weighting page of an exemplary appraiser valuation engine.

FIG. 6 illustrates yet another portion of a condition and weighting page of an exemplary appraiser valuation engine.

FIG. 7 illustrates a portion of a comparable property page of an exemplary appraiser valuation engine, the page portion showing a map that marks locations of the comparable properties and a subject property.

FIG. 8 illustrates another portion of a comparable property page of an exemplary appraiser valuation engine, the page showing a portion of a top-ranked comparable properties list.

FIG. 9 illustrates another portion of a comparable property page of an exemplary appraiser valuation engine, the portion showing another portion of a top-ranked comparable properties list.

FIG. 10 illustrates yet another portion of a comparable property page of an exemplary appraiser valuation engine, the page showing a portion of an alternative comparable properties list,

FIG. 11 illustrates yet another portion of a comparable property page of an exemplary appraiser valuation engine, showing a portion of an alternative comparable properties list.

FIG. 12 illustrates a portion of an estimated value page of an exemplary appraiser valuation engine.

FIG. 13 illustrates another portion of an estimated value page of an exemplary appraiser valuation engine.

FIG. 14 illustrates operations of an exemplary appraiser valuation engine.

FIG. 15 illustrates an exemplary system useful in implementations of the described technology.

### DETAILED DESCRIPTION

Subjective property characteristics are not well utilized in real estate appraisal processes. First, while objective property characteristics are easily obtained from public records databases and property information services, such as a Multiple Listing Service (MSL), sources of reliable and consistent subjective property characteristics are rare or non-existent. Furthermore, typical property valuation systems, such as Automatic Valuation Models (“AVMs”), are not configured to operate on subjective data. For example, the condition (e.g., the physical and aesthetic condition) of a property is an important property characteristic to be considered when setting a value of a property. However, in contrast to objective property characteristics, such as square footage, the condition of a property has substantial subjective components that do not lend themselves to quantitative comparison in a typical property valuation system. For example, whether new bathroom features contribute positively to the value of a house is a subjective consideration.

Moreover, such subjective characteristics influence both the value of a property being appraised as well as comparable properties considered in the appraisal process. As such, an exemplary property appraisal system collects and quantifies subjective information about the condition of a subject property as well as the conditions of potential comparable properties in order to evaluate this information using an appraiser valuation engine. Other subjective property characteristics may also be considered in this manner.

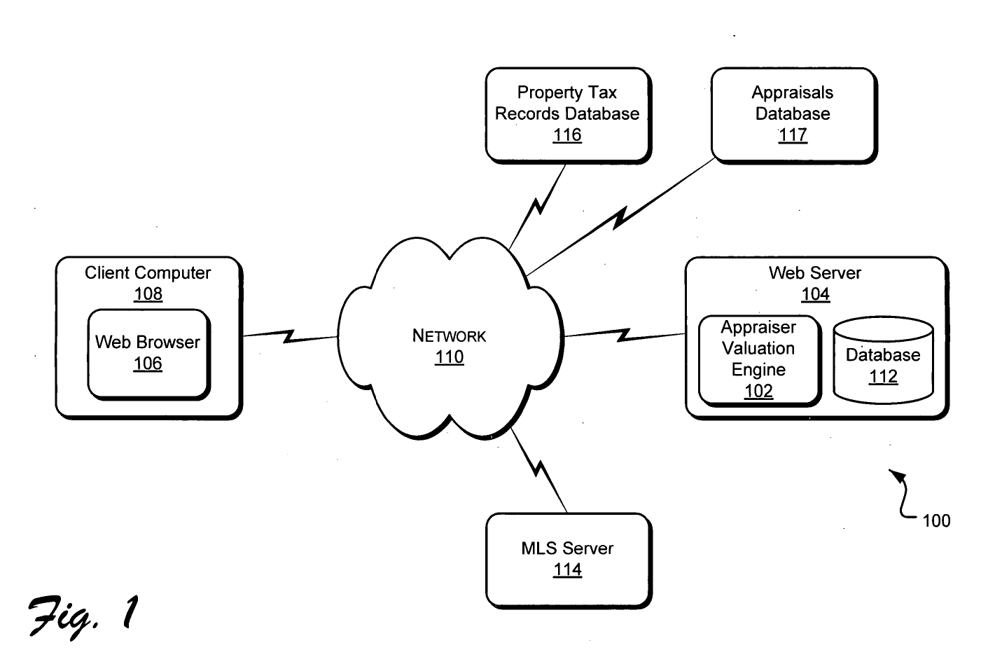

FIG. 1 illustrates an exemplary system 100 for providing property appraisals using subjective property characteristics. In the illustrated implementation, an appraiser valuation engine 102 resides on a web server 104 and accesses an appraisal system database 112. In an exemplary scenario, an appraiser will access the appraiser valuation engine 102 across a communications network 110 using a web browser 106 on a client computer 108. However, alternative implementations are contemplated, including non-web-based solutions and configurations where the user accesses an appraiser valuation engine that is resident on the client computer, rather than on a server computer.

The appraisal valuation engine 102 has access to property information, such as information available from a Multiple Listing Service (MLS) server 114, property tax records databases 116, and appraisals databases 117, although other property information sources may also be employed. Subject property data may be retrieved from these databases. In one implementation of the described system, the comparable property data is also available from the remote databases and is periodically (e.g., nightly) downloaded, “cleaned”, and stored in the appraisal system database 112. Alternatively, or in addition, comparable property data may be downloaded responsive to a request from a user and stored at that time in the appraisal system database 112.

When using the system 100 in the illustrated scenario, the appraiser is attempting to determine an accurate value of a subject property. One stage of this valuation process is to find reference properties with characteristics that are “comparable” to those of the subject property. Valuation judgments about the subject property can then be based on characteristics of these comparable properties, such as recent sale prices.

As such, the appraiser accesses the appraiser valuation engine 102 and inputs information that identifies the subject property, such as the property's address. Given the identification information about the subject property, the appraiser valuation engine 102 may access one or more property information sources (e.g., 112, 114, 116, and/or 117) to obtain relevant real estate property data, such as MLS data, tax assessment data, previous sale data, previous appraisal data, etc. In addition, the appraiser valuation engine 102 can retrieve real estate property data for potentially comparable properties from the same sources. Generally, the real estate property data for both the subject property and the potentially comparable properties includes both objective property characteristics and subjective property characteristics.

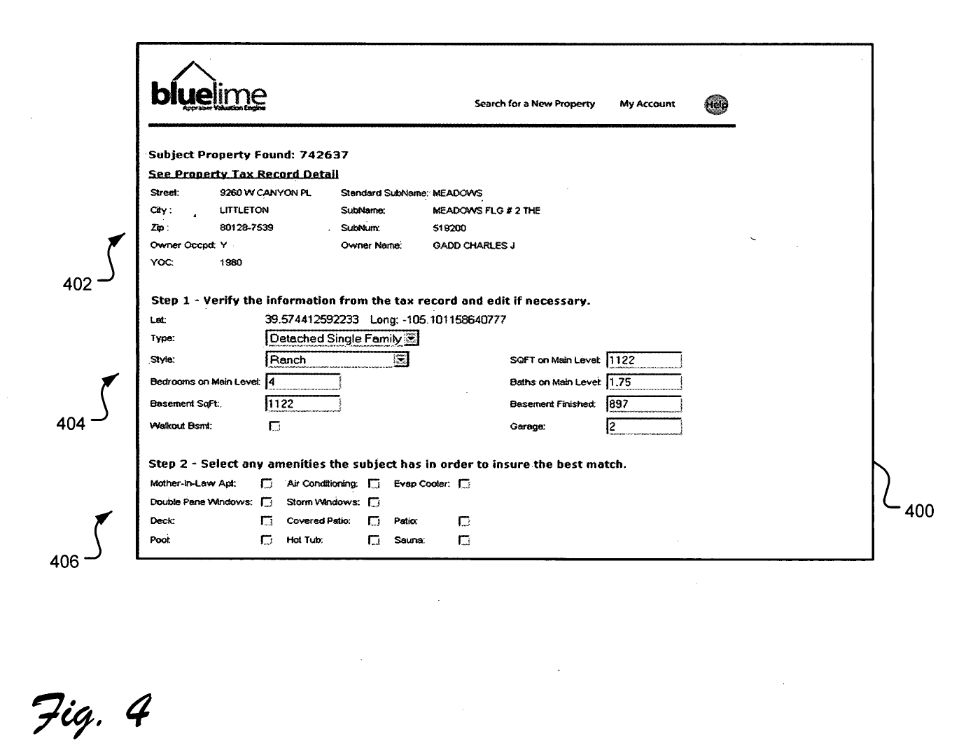

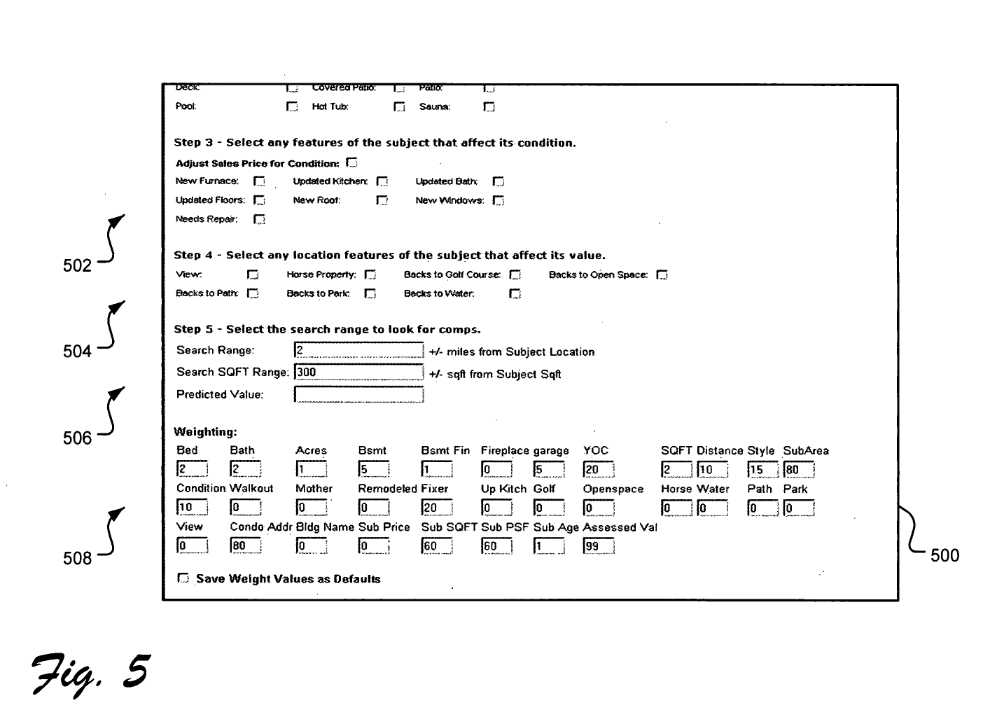

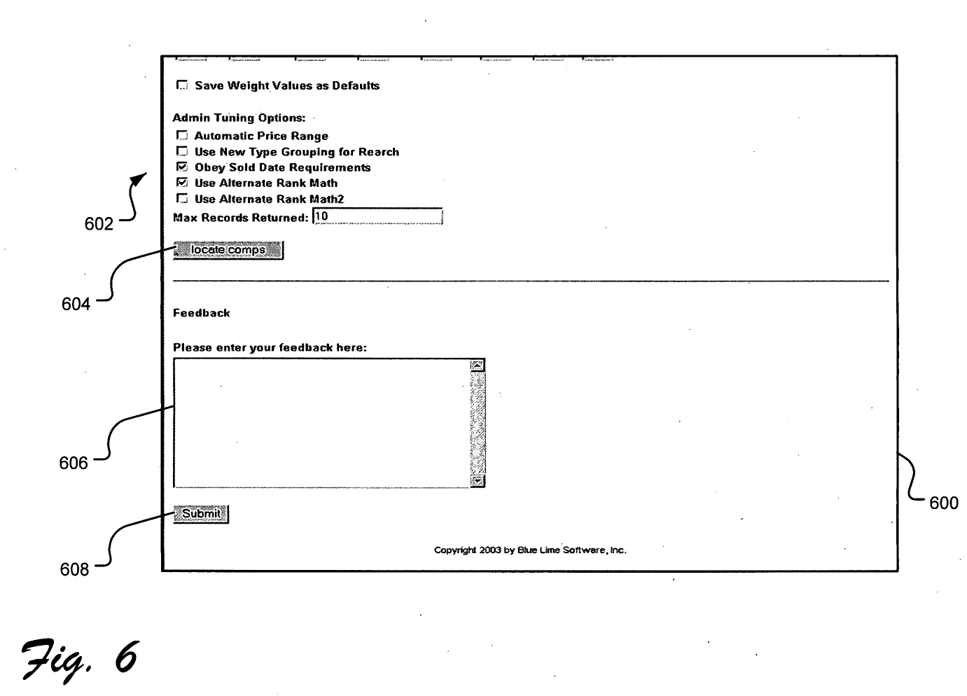

The appraiser may add additional characteristics to the profile of the subject property data to improve the description of the property and thereby improve the retrieval of more similar reference properties. Examples of such additional characteristics are displayed in a Condition and Weighting Page in the web browser 106. See, for example, the page portions 400 in FIG. 4, 500 in FIG. 5, and 600 in FIG. 6. The appraiser is then prompted to enter additional information, including special amenities, such as “Pool” or “Storm Windows”, condition characteristics, such as “Needs Repair” and “Updated Bathroom”, location features, such as “View” or “Horse Property”, and other characteristics (all of which may be considered to have subjective “condition” characteristics for the purposes of this description).

As discussed below, condition contribution scores are assigned to different characteristics of the subject property. The condition contribution scores for each property may be combined and converted into a composite condition score, which may be used in identifying appropriate comparable properties and determining the value of the subject property.

It should be understood that these additional characteristics may vary from implementation to implementation of an appraiser valuation engine 102, and from region to region. For example, anticipated condition characteristics in New York City may vary from those in Denver. As such, an appraisal valuation engine for use in Manhattan may omit a “Horse Property” selection, while an appraisal valuation engine for use in Denver may omit a “Near Subway” selection.

To incorporate subjective condition information into one implementation of the appraisal process, condition scores are also computed for the potentially comparable properties. Relevant text in the MLS listings for these properties, for example, may be pattern-matched to identify key condition data (e.g., key condition words and phrases). Such key condition data may be categorized into predefined categories, which are attributed with condition contribution scores. Such scores may be combined to obtain a composite condition score, which can be used to more accurately rank comparable properties in comparison to the subject property.

It should be understood that a similar process of pattern-matching textual remarks about the property may also be employed for the subject property, although the pattern-matching of text may be unnecessary, as the appraiser may select defined condition properties in the illustrated example. Nevertheless, the key condition data may also be extracted from substantive descriptions of the property provided by a realtor, the appraiser, etc.

Having scored the condition of the subject property and the potentially comparable properties, the potential comparable properties are ranked according to a variety of objective property characteristics, which now includes the composite condition score. The “most” comparable properties are identified as the “comparable” properties (or the “comps”) for the subject property, although the appraiser may replace one or more of these properties with other, initially lower-ranking properties using the user interface. The resulting comparable properties are then analyzed by the appraiser valuation engine 102 to generate a proposed value for the subject property. In one implementation, the composite condition score of the subject property can also be used to adjust the base valuation of the subject property, based on the perceived condition of the property, to yield a condition-adjusted valuation.

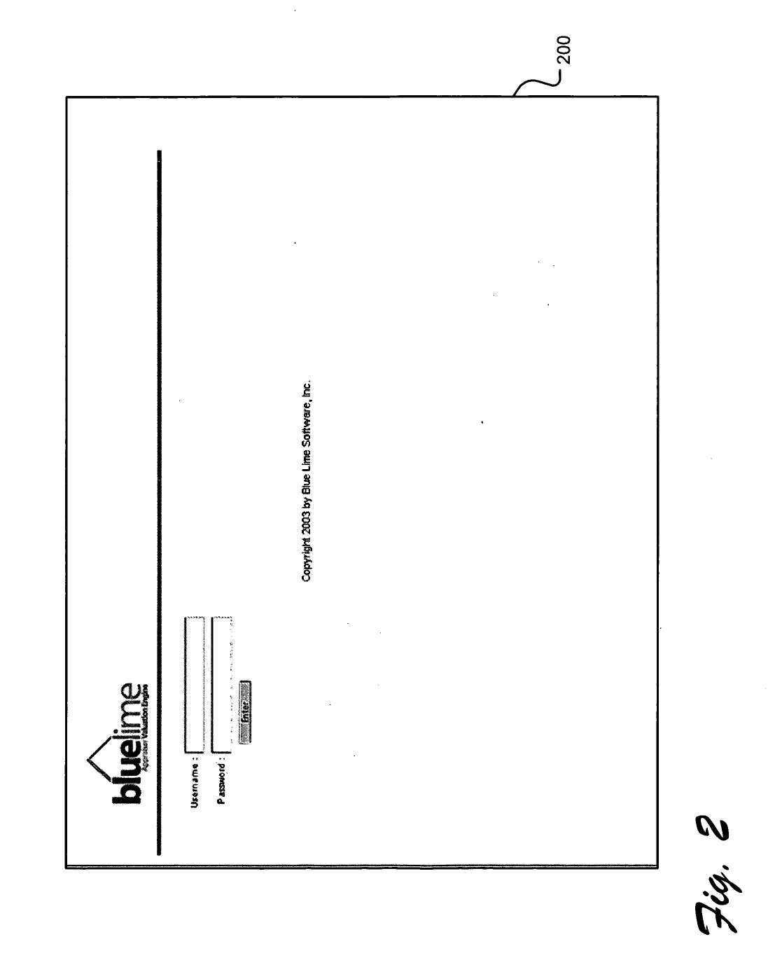

FIG. 2 illustrates a login page 200 of an exemplary appraiser valuation engine. The login page 200 includes a name field and a password field in which a user (e.g., an appraiser) enters his/her name and password to access the appraiser valuation engine. Having entered the login information, the user can select an “enter” button on the login page 200 to gain access to the appraiser valuation engine.

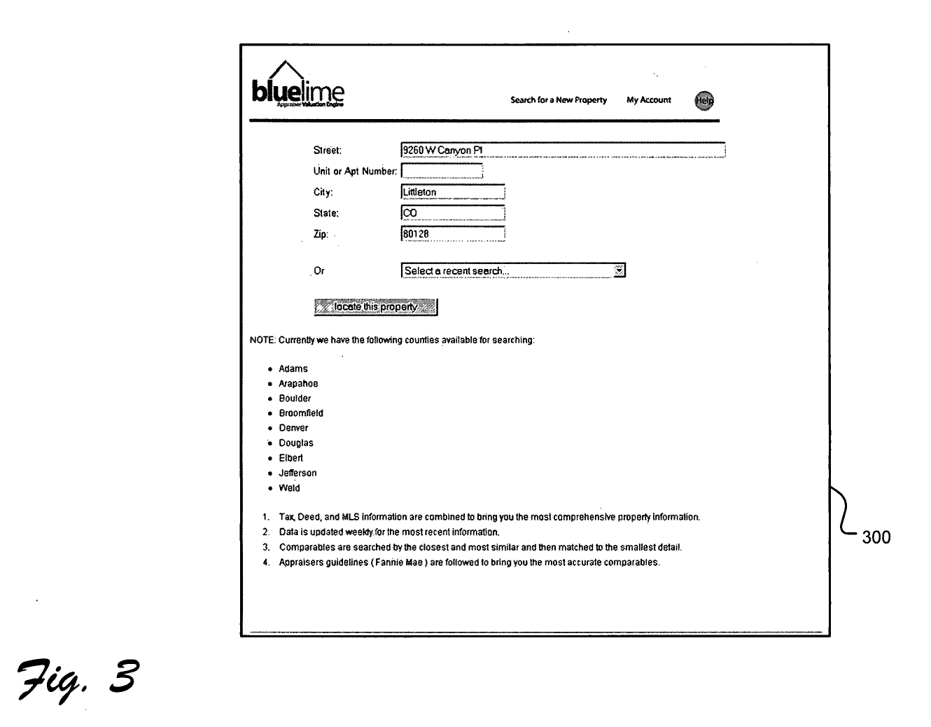

FIG. 3 illustrates a property identification page 300 of an exemplary appraiser valuation engine. The user can enter identification information about the subject property (i.e., the property being appraised), such as an address, although other identification information may be used (e.g., a previous search identifier, a computer-generated unique identifier, or a user-specified name or identifier).

After the user identifies the subject property, the user selects a “locate” button. The identification data is then sent to the appraiser valuation engine, which locates the subject property in one or more property data sources, such as an appraisal system database or remote data sources, such as an MLS database. If the subject property is not found, an error may be issued to the user, telling the user that the subject property was not located. If the subject property is located, the appraiser valuation engine generates a condition and weighting page, such as the page portions 400, 500, and 600 shown in FIGS. 4, 5, and 6, so that the user can continue with the appraisal process. The user may also select another recent search, for which comparable property results have already been processed.

FIG. 4 illustrates a portion of a condition and weighting page 400 of an exemplary appraiser valuation engine. A subject property identification information section 402 includes the subject property address, owner name, year of construction (YOC), sub-division information, and other characteristics. The subject property identification information section 402 can also include one or more hyperlinks that will take the user to pages displaying additional tax, deed, and MLS information. In a tax information edit section 404, one or more fields contain data retrieved from a tax record database (e.g., Property Data Center (PDC)), which the user may verify and, if necessary, correct. An amenities selection section 406 includes one or more fields in which the user can enter property amenities of interest, such as “air conditioning”, “storm windows”, and other characteristics. In some implementations, these amenity selections may be used as condition data for the subject property.

FIG. 5 illustrates another portion 500 of a condition and weighting page of an exemplary appraiser valuation engine. A condition selection section 502 includes one or more fields in which the user can enter property conditions of interest, such as “kitchen updated”, “new furnace”, and others. A location selection section 504 includes one or more fields in which the user can specify any location features of interest, such as “view”, whether the property backs to open space, and other characteristics. A range selection section 506 includes one or more fields whereby the user may choose the scope of the comparable search in terms of geographic range, square-footage, and other characteristics, relative to the subject property. In some implementations, the condition and location selections may be used as condition data for the subject property.

A weighting entry section 508 includes weighting fields in which a user can set weighting factors associated with each of the property attributes of interest. The weighting values correspond to the level of importance the user associates with each property attributes. Thus, the user is able to assign weighting factors, or importance values, on property attributes that can be used to rank comparable properties and value the subject property. In one implementation, a larger weight implies that the associated attribute is of more importance, although other relationships may be employed.

FIG. 6 illustrates yet another portion 600 of a condition and weighting page of an exemplary appraiser valuation engine. An administrative section 602 includes checkboxes related to various administrative options for tuning the appraisal process. The tuning option “automated price range” refers to the implementation of a method that requires a maximum allowable price difference of +/−20% between the sale prices of the top three comparable properties chosen by the program. In other words, with “automated price range” selected, the program will not allow the sale prices of any two of the top three comparable properties to differ by more than +/−20%. The program may replace any or all of the top comparable properties with another comparable if the +/−20% price difference requirement is violated. If “automated price range” is not selected, the program will select the top three comparable properties based on their similarity to the subject property and other requirements, but with no regard for the price difference between the top three comparable properties. The tuning option “obey sold date requirements” refers to the implementation of a method that requires the sale dates of the top three comparable properties chosen by the program to meet certain requirements. In one implementation, when “obey sold date requirements” selected, the program requires that at least two of the three top comparable properties have sold dates less than 6 months from the current date. One of the three top comparable properties may have a sold date up to a year from the current date.

A selectable “locate comps” button 604, when selected by the user, causes the property data entered in the fields for the page to be sent to the appraiser valuation engine as a request for identification and ranking of comparable properties. A feedback field 606, in combination with a “submit” button 608, can be used to submit user comments or other feedback about the page to the service vendor maintaining the appraiser valuation engine.

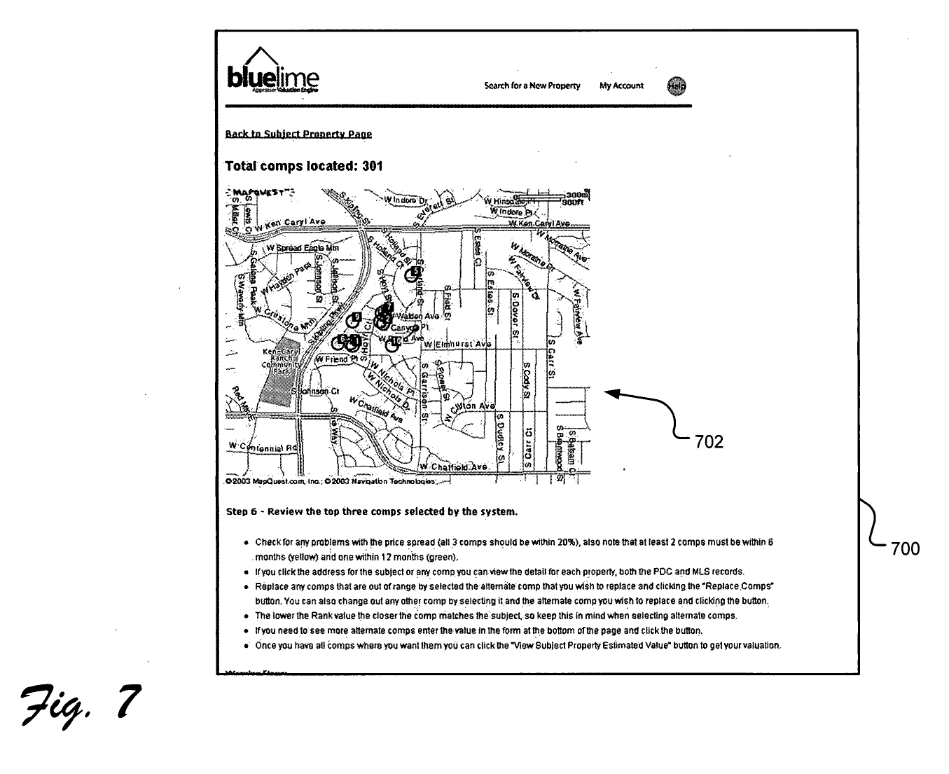

FIG. 7 illustrates a portion 700 of a comparable property page of an exemplary appraiser valuation engine, the page portion 700 showing a map 702 that marks locations of the comparable properties and a subject property. An appraiser valuation engine can generate the map 702 and present the map 702 to the user over a network. In one implementation, the numerals annotating each property indication on the map 702 represent the rankings of the associated properties in the ranked comparable property list.

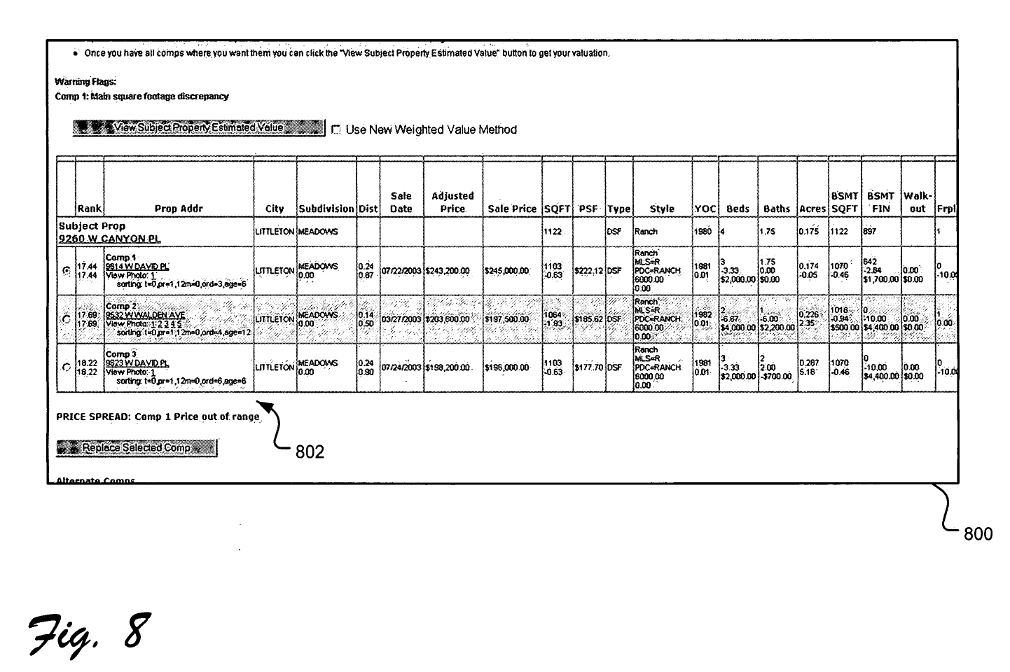

FIG. 8 illustrates another portion 800 of a comparable property page of an exemplary appraiser valuation engine, the page showing a portion of a top-ranked comparable properties list. The portion 800 includes a list 802 of comparable properties showing comparable property data elements and rank. The user may request an estimated value based on the shown comparable properties by selecting a “view subject property estimated value” button. The user may request that the value estimation be performed using a weighted value method by selecting a checkbox. The user may select a comparable property from the list 802 and request that one of the selected top three comparable properties be replaced by an alternate comparable property by selecting the “replace” button. This feature allows the user to adjust the ranking of the comparable properties.

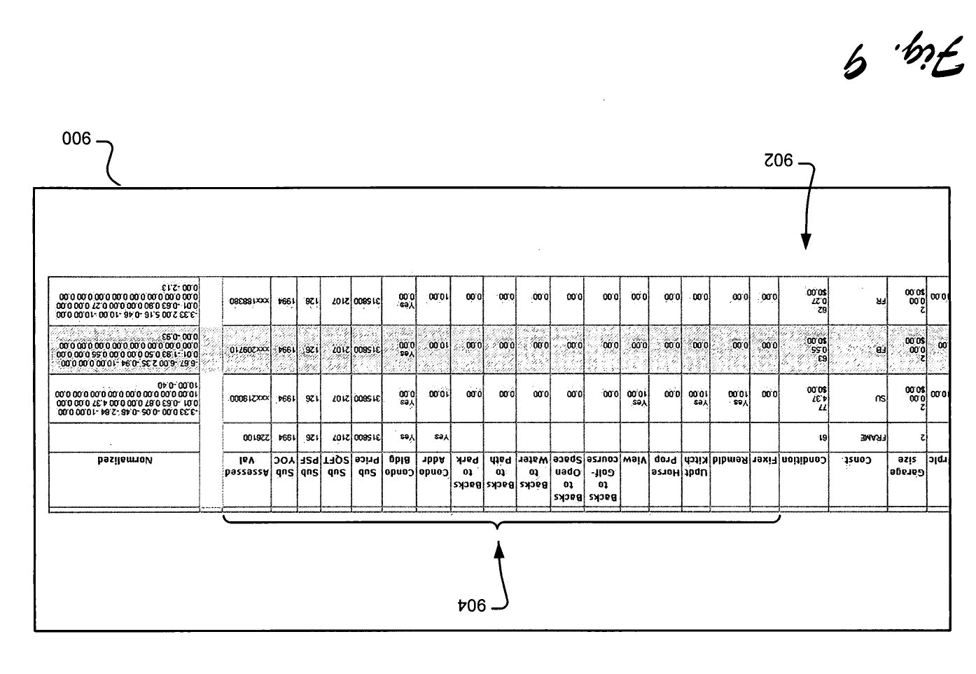

FIG. 9 illustrates another portion 900 of a comparable property page of an exemplary appraiser valuation engine, the portion showing another portion of a top-ranked comparable properties list. The portion 900 is an extension of the page portion 800 from FIG. 8. Thus, each row shown in FIG. 9 is corresponds to one of the comparable properties in the list 802 of FIG. 8. Of particular relevance in the portion 900 is the column labeled “condition” 902. The condition column 902 includes a condition score (e.g., a composite condition score) associated with each of the comparable properties. Specific condition categories that were analyzed to determine the condition scores are shown in columns 904.

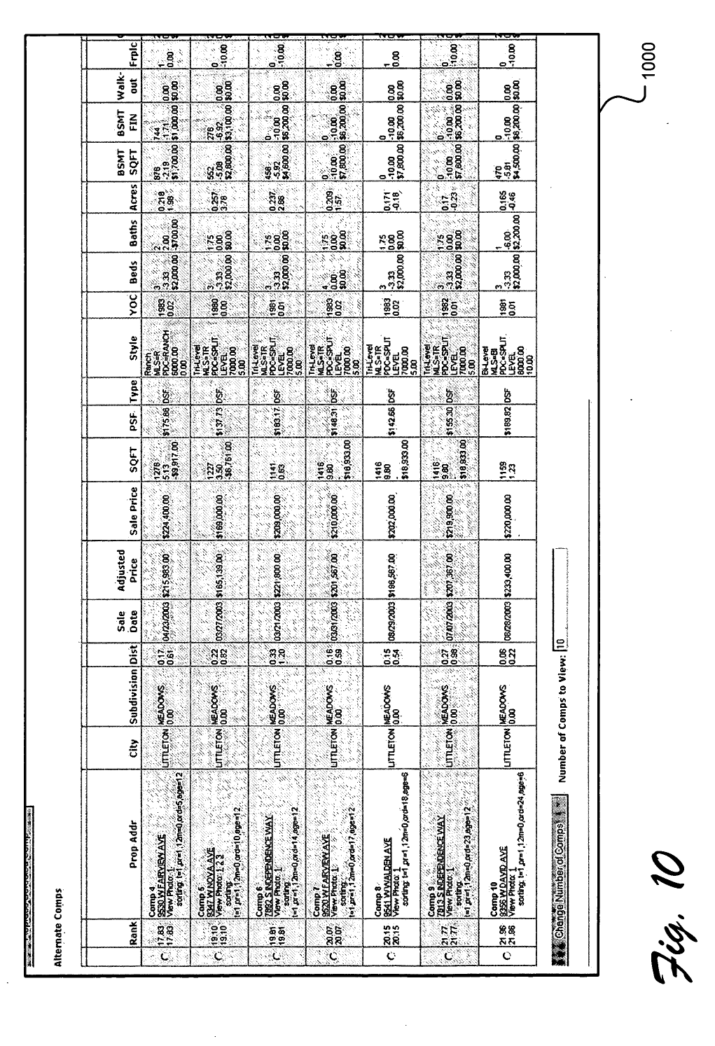

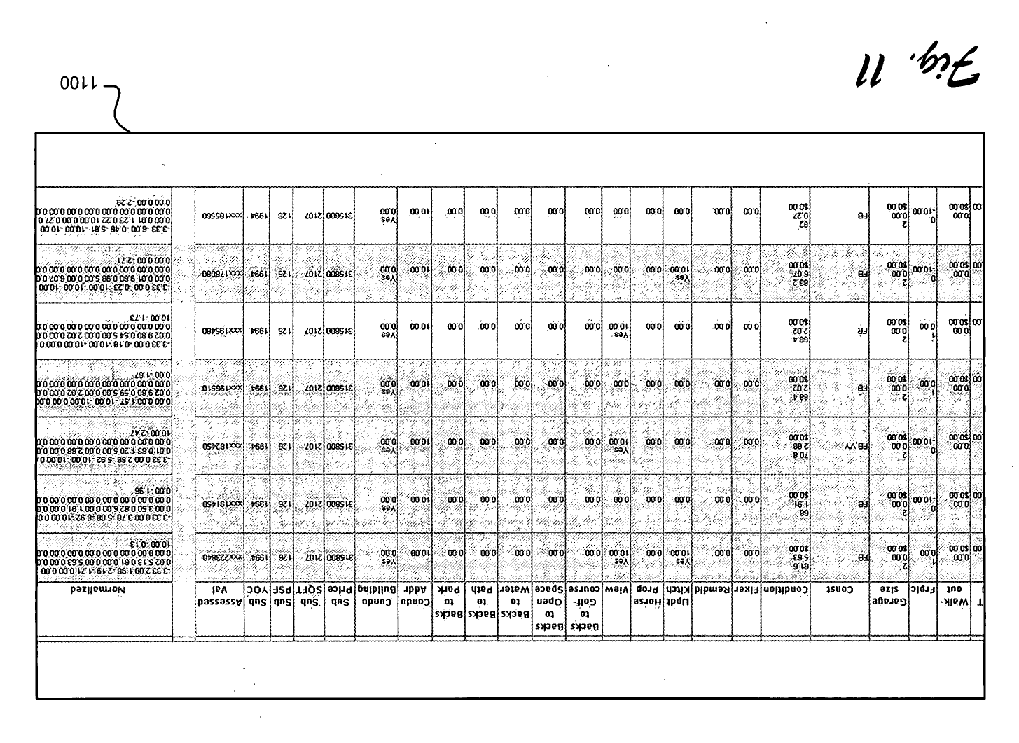

FIGS. 10 and 11 illustrate two other portions 1000 and 1100 of an exemplary comparable property data page wherein the portions include a list 1002 of alternate comparable property data showing comparable property attributes, including conditions and rank. The data shown in page portions 1000 and 1100 are analogous to the data shown in FIGS. 8 and 9, except that the data shown in FIGS. 10 and 11 pertain to alternate comparable properties. As mentioned above with regard to FIG. 8, the user may replace any of the comparable properties shown in the list 802 with an alternative comparable property shown in the list 1002 in FIG. 10. The page portion 1000 also includes a “change number” button, by which the user may change the number of comparable properties that are displayed in the top-ranked comparable properties list and/or are used in the valuation.

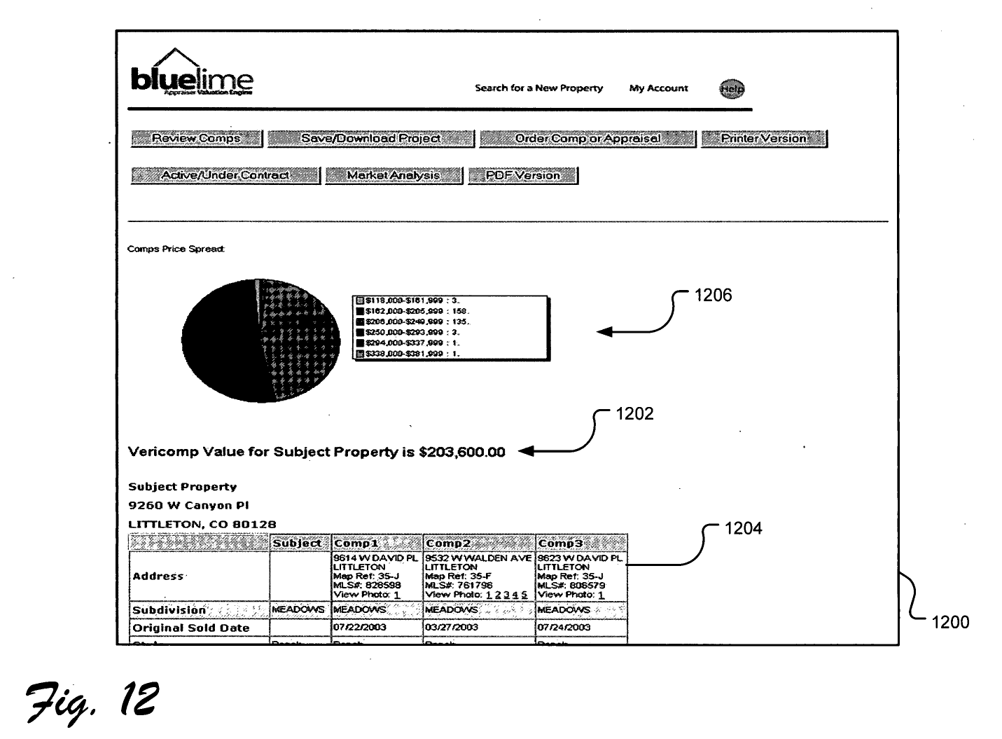

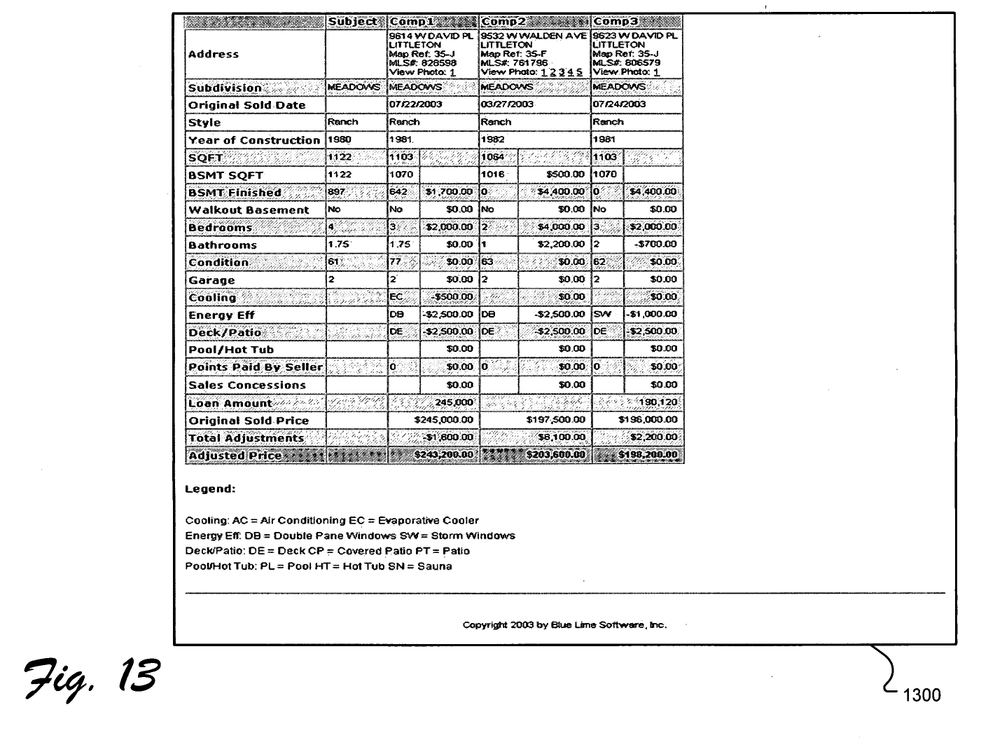

FIGS. 12 and 13 illustrate portions 1200 and 1300 of an estimated value page of an exemplary appraiser valuation engine. The estimated value page 1200 shows an estimated value 1202 of the subject property based on the comparable properties selected in the comparable pages shown in FIGS. 8-11. A comparable property summary table 1204 summarizes various property attributes, conditions, amenities, selling prices, and the like, which were analyzed in deriving the estimated value 1202. A comparable property price distribution graph 1206 illustrates ranges of prices of comparable properties and the proportions of the number of comparable properties in those ranges.

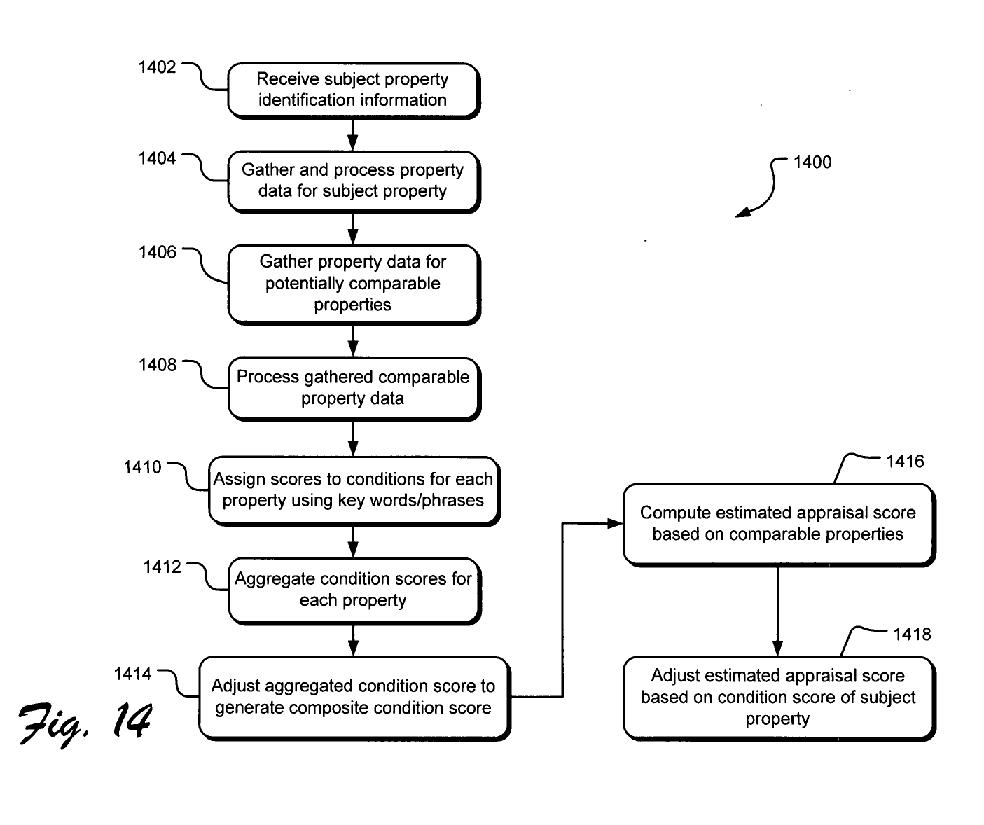

FIG. 14 illustrates operations 1400 of an exemplary appraiser valuation engine. A receiving operation 1402 receives identification information for a subject property to be appraised. A gathering operation 1404 gathers and processes property data for the subject property and may involve receipt of property data from various sources, including an MLS server, a static MLS data source (e.g., a CD-ROM or hard disk), a tax assessment database, the appraiser, etc.

Another gathering operation 1406 gathers property data for comparable properties related to the subject property. The gathering operation 1406 may also involve various data sources and may be performed by reading MLS or other property data from a disk, receiving the MLS property data from an MLS server, or other data gathering mechanisms. After the property data is gathered, it is processed by a processing operation 1408, which performs any preliminary processing necessary to put the MLS or other property data into a format appropriate for the appraisal process. Typically, the processing operation 1408 “cleans” the property data, which may include, but is not limited to, normalizing, geocoding, and formatting the property data. The processing operation 1408 stores the cleaned property data in storage (e.g., memory or disk) that is accessible by the appraiser valuation engine.

In one implementation of the operations 1400, the gathering operation 1406 and the processing operation 1408 are performed before the receiving operation 1402. In such implementations, the gathering operation 1406 and processing operation 1408 may be performed periodically (e.g., nightly), so that when an appraisal request is received, more or less recent property data is already cleaned and stored within local storage of the appraiser valuation engine.

In addition, the processing operation 1408 extracts key condition data from the property data. For example, a remarks or comments field may be returned in the MLS data relating to a given property. Therefore, a pattern-matching operation (e.g., using a lexical analyzer and a parser to search for commonly-used realtor comments) may be performed on this field to extract key words and phrases indicative of subjective condition characteristics. These key words and phrases may be mapped to key condition data, which may be then used to discern a quantitative condition score for the property. Other property data fields may also provide relevant key condition data.

An assigning operation 1410 categorizes the key condition data, wherein each category is assigned a condition score. In one implementation, the condition points assigned are based on the estimated “cost to build/replace/renovate” associated with a particular condition item. To illustrate, expensive (i.e., higher valued) items like an updated kitchen may be assigned more points than, for example, an updated bath, since a kitchen renovation generally costs more and increases valuation more than a bathroom renovation. To illustrate further, a particular implementation of the appraiser valuation engine 110 assigns points to particular condition items found in the comments or the “Description” section of the MLS 112. Below are exemplary condition categories with the categories' associated points.
1. Updated Kitchen and Bath—15.8 points
2. Updated Kitchen—13.2 points
3. Updated Flooring—4.4 points
4. New Windows—4.4 points
5. Updated Bath—2.6 points
6. New Roof—2.6 points
7. New Furnace—2.6 points
8. Fix-up Property—30 point base

With regard to the exemplary condition items shown above, the greater of the total points for condition items 1-7 above or the 15 points given for an “Updated” and/or “Remodeled” from the “Description” section is used. The scoring of a property will start with some base points, depending on the age of the property and whether the property requires fixing up or refurbishing (i.e., a “fix-up property”). The base points are assigned as follows:
Property less than 5 years old: 80 point base
Property from 6 years old up to 35 years old decreased by 1 point a year from 80 points, so a 6 year old house gets 79 points, 7 years old gets 78 points, etc. with a 35 year old getting 50 points.
Any house over 35 years old: 50 point base
Any “Fix-Up” Property (no matter what age): 30 point base

Points are added for items 1-7 given above. An old property that has been completely updated will score about 80 points (50 point base+30 points maximum in updating). Newer properties with upgrades will score between 75 and 100 points (not to exceed 100 points). “Fix-up” properties start with low base points to differentiate such properties from the other properties. Points can be added for the above condition items to a fix-up property, but a typical fix-up property will not have points associated with condition categories 1-7 above. Between the “Comments” and the “Description” sections in the MLS data, points are typically counted once for each particular condition category.

In a particular implementation of the appraiser valuation engine 110, the points for the condition categories are derived using the approximate cost for each item in a $200,000.00 house. In this implementation, the dollar amounts were scaled to a 30 point base. The assumption is that the cost to renovate a house goes up linearly with the price of the house. This is not necessarily true, but some assumptions can be made to simplify the condition scoring process.

The condition scoring system described may be refined to suit a particular implementation. For example, another condition category may pertain to “General updating”. The general condition category could be used for non-specific phrases like “totally renovated” or “completely updated”. The condition score becomes a property attribute that can be individually weighted and included in the similarity formula.

An aggregating operation 1412 aggregates the condition scores for all of the individual property conditions that were scored for each of the properties to yield a composite condition score for each property.

Particular implementations of the operations 1400 will compute a “condition score” for each comparable property based on the age of the property and information obtained from the “comments” and “description” section of the MLS data. Based on this condition score, properties will be classified as being in Poor, Fair, Average, Average +, Good, or Excellent condition. The condition classification can be used during the comparison and/or ranking with the comparable properties based, on the relative condition classifications of all of the properties.

In one particular implementation, the scoring is as follows:
Poor 0-35 points, set subject at 30 points
Fair 36-49 points, set subject at 42 points
Average 50-69 points, set subject at 60 points
Average + 70-79 points, set subject at 75 points
Good 80-90 points, set subject at 85 points
Excellent 91-100 points, set subject at 95 points

In one particular implementation, exemplary definitions for each of the condition classifications are used:
Poor—“Fix-up” properties. Properties that have been neglected and require complete renovation.
Fair—Properties in below average condition with excessive deferred maintenance and minimal updating.
Average—Well-maintained older properties (over 15 years old) with minimal deferred maintenance. Properties may have some updating, although not extensive.
Average +—Well-maintained newer properties (less than 15 years old) and older properties that have been completely updated.
Good—Well-maintained new properties (less than 5 years old), newer properties (5-15 years old) with some updates/upgrades, or older properties (15+ years old) with extensive updating.
Excellent—High-end custom homes, new homes with many upgrades, or older homes in pristine condition that have undergone a meticulous restoration or high-end renovation.

An adjusting operation 1414 adjusts the aggregated condition scores based on various attributes of the associated properties, such as the properties' ages. Thus, aggregated scores for older properties will be decreased or increased accordingly.

An estimating operation 1416 ranks the comparable properties relative to the subject property and estimates a subject property value based on the comparable property characteristics. In one implementation, an estimating operation selects the most similar comparable properties and generates the estimated value based on a weighted average of the sale prices of the selected comparable properties. Another adjusting operation 1418 adjusts the estimated value based on one or more condition scores of the subject properties.

A particular implementation of the adjusting operation 1418 uses customized one-line adjustments. The following examples are shown to illustrate a one-line adjustment process:

1. Condition:

Apply a 0.25% adjustment for every point difference in the condition score.
Apply a 0.5% adjustment for any point difference in the condition score if one of the properties has a condition score below 50 points (indicating it's a fixer). If both properties score below 50 points use the 0.25% adjustment. The total percentage adjustment is applied to the sale price of the comparable.
Example 1:
   Subject
   Sale Price=150,000
   Condition Score=65
   Comparable
   Sale Price=140,000
   Condition Score=50
   Adjustment=(65−50)*0.25=+3.75%, 0.0375*140,000=+$5250.00
Example 2:
   Subject
   Sale Price=120,000
   Condition Score=35 points (fix-up property)
   Comparable
   Sale Price=150,000
   Condition Score=50 points
   Adjustment=(35−50)*0.5=−7.5%, 0.075*150,000=−$11,250
   2. Main Level (Above Grade) Square Footage
For any square footage difference greater than 100 square feet, multiply ⅓ of the average PSF for all three comps by the square footage difference between the subject and the comp.
   3. Basement Square Footage
For any square footage difference over 100 square feet, adjust $7.00/SF for houses priced 200-400K. Adjust $10.00/SF for houses 400K and up.
   4. Basement Finished Square Footage
Adjust $7.00/SF for houses 200-400K. Adjust $10.00/SF for houses 400K and up.
   5. Main Level (Above Grade) Bedrooms
Adjust $2000.00 per bedroom.
   6. Main Level (Above Grade) Bathrooms
Adjust $2500.00 per full bathroom and $1500.00 per half bathroom.
   7. Heating/Cooling
$2000.00 adjustment for air conditioning (AC in description section)
$500.00 for an evaporative cooler (EC in description section).
   8. Energy Efficient Items
$2500.00 adjustment for double pane windows (DB in description section)
$1000.00 adjustment for storm windows (SW in description section)
   9. Garage
$3000.00 adjustment per car space
   10. Patios and Decks
$2500.00 adjustment for deck (DE in description section)
$1500.00 adjustment for covered patio (CP in description section)
$1000.00 adjustment for patio (PT in description section)
Note: adjust only once for patio (greater of the two)
   11. Fireplace
$1000.00 adjustment for Fireplace, Gas Logs (GL), Pellet Stove (PS), or Wood
Stove (WS).
   12. Pool, Sauna, Hot Tub, etc.
$4000.00 for Pool (PI, PL, PO)
$2000.00 for Hot Tub (HT)
$2000.00 for Sauna (SN)
   13. Walkout Basement
$6000.00 for houses 150-300K
$10,000.00 for houses 300K and up.
   14. Heating/Cooling (alternative)
If the subject or comp has both AC and an evaporative cooler, we give it the greater of the two (AC in this case) and adjust for the difference between AC and EC, which would be $1500.00.
   15. Energy Efficient Items (windows)
If the subject or comp has both double pane windows (or new windows) and storm windows, it is given the greater of the two (double panes in this case) and adjust for the difference between double panes and storm windows, which would be $1500.00.
   16. Decks, Patios, Covered Patios (alternative)
If the subject or comparable property has both a deck and a patio, the subject or comparable property is assigned the greater of the two or three (deck in this case) and adjust for the difference between deck and patio ($1500.00), or covered patio versus patio ($500.00).
   17. Fireplace (alternative)
For fireplace count, take the greater of the fireplace field count and the number of fireplaces found in the description section. This should prevent counting the same fireplace twice. For example, if a property has 2 fireplaces specified in the fireplace field and has gas logs (GL) specified in the description section, 2 fireplaces are assumed.

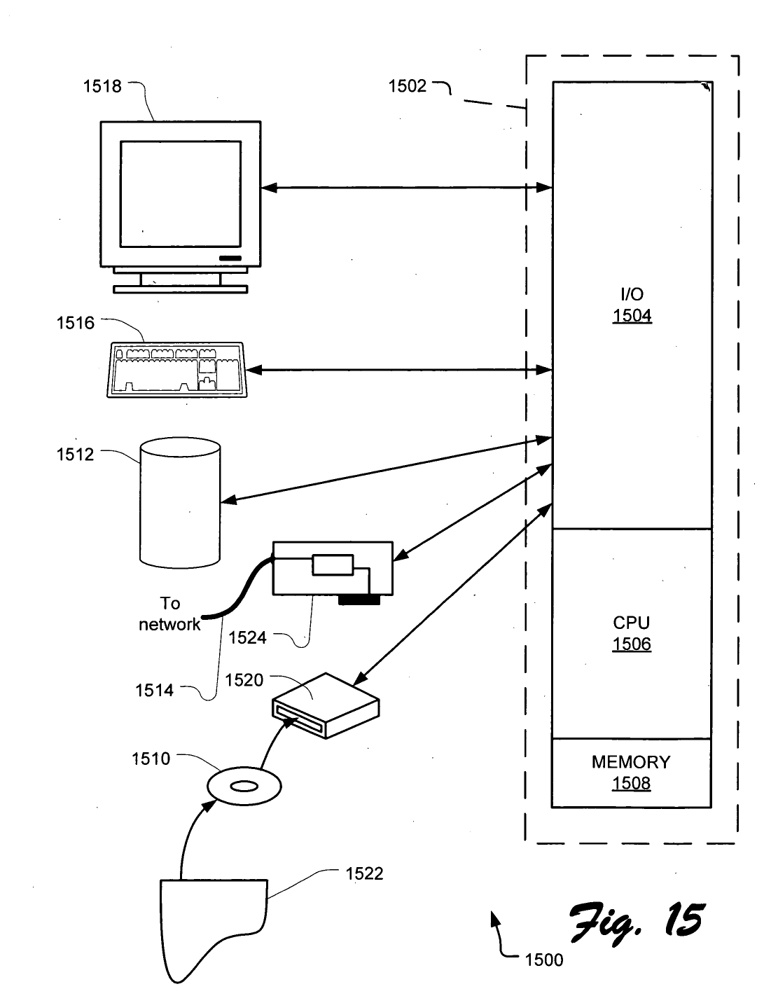

FIG. 15 illustrates an exemplary system useful in implementations of the described technology. A general purpose computer system 1500 is capable of executing a computer program product to execute a computer process. Data and program files may be input to the computer system 1500, which reads the files and executes the programs therein. Some of the elements of a general purpose computer system 1500 are shown in FIG. 15 wherein a processor 1502 is shown having an input/output (I/O) section 1504, a Central Processing Unit (CPU) 1506, and a memory section 1508. There may be one or more processors 1502, such that the processor 1502 of the computer system 1500 comprises a single central-processing unit 1506, or a plurality of processing units, commonly referred to as a parallel processing environment. The computer system 1500 may be a conventional computer, a distributed computer, or any other type of computer. The described technology is optionally implemented in software devices loaded in memory 1508, stored on a configured DVD/CD-ROM 1510 or storage unit 1512, and/or communicated via a wired or wireless network link 1514 on a carrier signal, thereby transforming the computer system 1500 in FIG. 15 to a special purpose machine for implementing the described operations.

The I/O section 1504 is connected to one or more user-interface devices (e.g., a keyboard 1516 and a display unit 1518), a disk storage unit 1512, and a disk drive unit 1520. Generally, in contemporary systems, the disk drive unit 1520 is a DVD/CD-ROM drive unit capable of reading the DVD/CD-ROM medium 1510, which typically contains programs and data 1522. Computer program products containing mechanisms to effectuate the systems and methods in accordance with the described technology may reside in the memory section 1504, on a disk storage unit 1512, or on the DVD/CD-ROM medium 1510 of such a system 1500. Alternatively, a disk drive unit 1520 may be replaced or supplemented by a floppy drive unit, a tape drive unit, or other storage medium drive unit. The network adapter 1524 is capable of connecting the computer system to a network via the network link 1514, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1500 is connected (by wired connection or wirelessly) to a local network through the network interface or adapter 1524, which is one type of communications device. When used in a WAN-networking environment, the computer system 1500 typically includes a modem, a network adapter, or any other type of communications device for establishing communications over the wide area network. In a networked environment, program modules depicted relative to the computer system 1500 or portions thereof, may be stored in a remote memory storage device. It is appreciated that the network connections shown are exemplary and other means of and communications devices for establishing a communications link between the computers may be used.

In accordance with an implementation, software instructions directed toward determining a condition score for a comparable property, wherein the condition score characterizes a level of similarity of a predetermined condition of the comparable property to the predetermined condition of a subject property may be stored on disk storage unit 1509, disk drive unit 1507 or other storage medium units coupled to the system. Said software instructions may also be executed by CPU 1506.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

The above specification, examples and data provide a complete description of the structure and use of exemplary embodiments of the invention. Since many embodiments of the invention can be made without departing from the spirit and scope of the invention, the invention resides in the claims hereinafter appended.

1. A computer program product encoding a computer program that executes a computer process for quantifying condition of a real estate property, the computer process comprising:
receiving real estate property data that includes a plurality of subjective condition characteristics relating to the real estate property;
extracting key condition data from the subjective condition characteristics in the real estate property data;
categorizing elements of the key condition data from the real estate property data into one or more predefined condition categories, each predefined condition category being associated with a condition contribution score; and
associating a condition contribution score with the real estate property, if an element of the key condition data is categorized in the predefined condition category associated with the condition contribution score.

2. The computer program product of claim 1 wherein the computer process further comprises:
combining the condition contribution scores for the real estate property to generate a composite condition score that reflects the condition of the real estate property.

3. The computer program product of claim 1 wherein the computer process further comprises:
generating a composite condition score for a subject real estate property based on the condition contribution scores;
generating a composite condition score for a plurality of other real estate properties; and
ranking the other real estate properties in order to identify the most similar comparable properties relative to the subject real estate property, based on the composite condition score of the subject real estate property and the composite condition score of the other real estate properties.

4. The computer program product of claim 1 wherein the computer process further comprises:
generating a composite condition score for a subject real estate property based on the condition contribution scores;
computing a value of the subject real estate property based on a plurality of comparable real estate properties; and
adjusting the value of the subject real estate property based on the composite condition score.

5. The computer program product of claim 1 wherein the real estate property data is received from a multiple listing service.

6. The computer program product of claim 1 wherein the real estate property data is received from a property tax database.

7. The computer program product of claim 1 wherein the extracting operation comprises:
pattern matching text in the subjective condition characteristics of the real estate property data to identify one or more predetermined phrases as the key condition data.

8. The computer program product of claim 1 wherein the categorizing operation comprises:
associating each element of the key condition data with at least one of the predefined condition categories.

9. A method of quantifying condition of a real estate property, the method comprising:
receiving real estate property data that includes a plurality of subjective condition characteristics relating to the real estate property;
extracting key condition data from the subjective condition characteristics in the real estate property data;
categorizing elements of the key condition data from the real estate property data into one or more predefined condition categories, each predefined condition category being associated with a condition contribution score; and
associating a condition contribution score with the real estate property, if an element of the key condition data is categorized in the predefined condition category associated with the condition contribution score.

10. The method of claim 9 further comprising:
combining the condition contribution scores for the real estate property to generate a composite condition score that reflects the condition of the real estate property.

11. The method of claim 9 further comprising:
generating a composite condition score for a subject real estate property based on the condition contribution scores;
generating a composite condition score for a plurality of other real estate properties; and
ranking the other real estate properties in order to identify the most similar comparable properties relative to the subject real estate property, based on the composite condition score of the subject real estate property and the composite condition score of the other real estate properties.

12. The method of claim 9 further comprising:
generating a composite condition score for a subject real estate property based on the condition contribution scores;
computing a value of the subject real estate property based on a plurality of comparable real estate properties; and
adjusting the value of the subject real estate property based on the composite condition score.

13. The method of claim 9 wherein the real estate property data is received from a multiple listing service.

14. The method of claim 9 wherein the real estate property data is received from a property tax database.

15. The method of claim 9 wherein the extracting operation comprises:
pattern matching text in the subjective condition characteristics of the real estate property data to identify one or more predetermined phrases as the key condition data.

16. The method of claim 9 wherein the categorizing operation comprises:
associating each element of the key condition data with at least one of the predefined condition categories.

17. A system for quantifying condition of a real estate property, the system comprising:
means for receiving real estate property data that includes a plurality of subjective condition characteristics relating to the real estate property;
means for extracting key condition data from the subjective condition characteristics in the real estate property data;
means for catagorizing elements of the key condition data from the real estate property data into one or more predefined condition categories, each predefined condition category being associated with a condition contribution score; and
means for associating a condition contribution score with the real estate property, if an element of the key condition data is categorized in the predefined condition category associated with the condition contribution score.

18. A system for quantifying condition of a real estate property, the system comprising:
a data base that receives real estate property data including a plurality of subjective condition characteristics relating to the real estate property; and
an appraisal valuation engine that extracts key condition data from the subjective condition characteristics in the real estate property data, categorizes elements of the key condition data from the real estate property data into one or more predefined condition categories, wherein each predefined condition category being associated with a condition contribution score, and associates a condition contribution score with the real estate property, if an element of the key condition data is categorized in the predefined condition category associated with the condition contribution score.
